(19) United States
(12) Patent Application Publication
(10) Pub. No.: US 2011/0162474 A1
(43) Pub. Date: Jul. 7, 2011

(54) Slap stick shifter

(76) Inventor: Robert Leeflang, Bluffdale, UT (US)

(21) Appl. No.: 12/925,035

(22) Filed: Feb. 15, 2011

Related U.S. Application Data
(60) Provisional application No. 61/279,456, filed on Oct. 21, 2009.

(51) Int. Cl. F16H 59/04

(52) U.S. Cl. 74/473.3

(57) ABSTRACT

A hand operated shift lever that connects to the existing shift spline and linkage of Harley Davidson Motorcycles. This shift lever replaces the existing heel shifter.

Consists of a shift spline adaptor lever machined and adapted to ¾ O.D. tubing.

The tubing, which can come in various lengths to adapt to the rider of the motorcycle, is attached to the spline adaptor and may come in various shapes, angles, bends or material types.

A shifter knob is machined and attached to the top of the tubing.

### BRIEF SUMMARY OF THE INVENTION

Gives motorcycle rider the option to shift gears by hand operation rather than by foot operation.

### BRIEF DESCRIPTION OF THE DRAWING

FIG. 1- Shift spline adaptor lever is attached to the existing shift lever which replaces the heel shift lever. Tubing is attached to the shift spline adaptor lever. A shift knob is attached to the tubing.

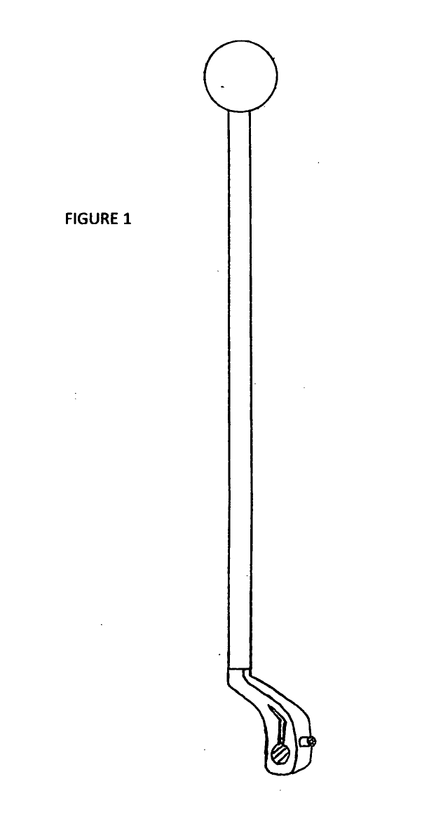

FIG. 2- This is a side view of FIG. 1.

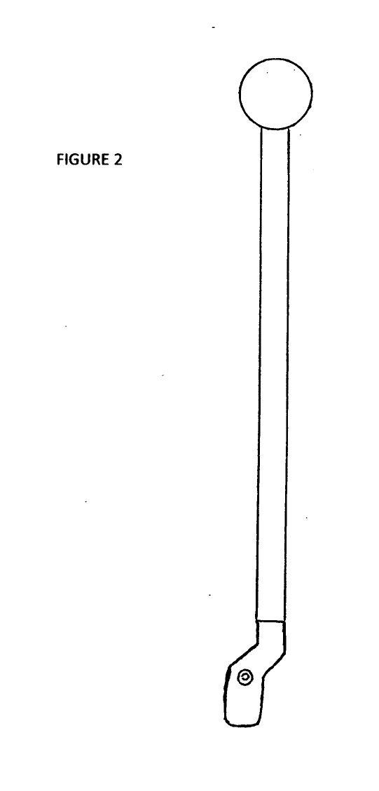

### DETAILED DESCRIPTION OF THE INVENTION

A hand operated shift lever that connects to the existing shift spline and linkage of Harley Davidson Motorcycles. This shift lever replaces the existing heel shifter.

Consists of a shift spline adaptor lever, machined and adapted to ¾ O.D. tubing.

The tubing, which can come in various lengths to adapt to the rider of the motorcycle is attached to the spline adaptor and may come in various shapes, angles, bends, and material types.

A shifter knob is machined and attached to the top of the tubing.

What is claimed is:

1. A slap stick shifter, a hand operated motorcycle gear change device, the slap stick shifter comprising: a shift spline adaptor, chrome tubing and a shift knob that are machined and put together and configured to fit on the shift spline of a motorcycle to allow a hand operated shifting of gears and may be configured in shapes and lengths to fit application or physical reach of user.

2. The slap stick shifter as defined in claim 1, is designed to replace the heel shifter on a heel/toe style shifter on motorcycles.
